(19) United States
(12) Patent Application Publication
(10) Pub. No.: US 2019/0043042 A1
(43) Pub. Date: Feb. 7, 2019

(54) METHOD, SYSTEM, AND DEVICE FOR PROCESSING DIGITAL PAYMENTS VIA DIGITAL WALLET UPON DELIVERY OF ITEM

(71) Applicant: Mastercard International Incorporated, Purchase, NY (US)

(72) Inventor: Pradip Dagadu Kadam, Pune (IN)

(73) Assignee: Mastercard International Incorporated, Purchase, NY (US)

(21) Appl. No.: 16/018,822

(22) Filed: Jun. 26, 2018

(30) Foreign Application Priority Data
Aug. 1, 2017 (SG) 10201706267U

(51) Int. Cl. G06Q 20/36; G06Q 20/40

(52) U.S. Cl. CPC G06Q 20/3674; G06Q 20/401

(57) ABSTRACT

A method, system, and device for processing a digital payment via a digital wallet upon delivery of an item is disclosed. The method includes receiving a payment collection request by the consumer. The payment collection request embeds item-related information that includes at least details of a merchant selling the item, order details for the item, or a payment amount for the item. The method further includes detecting a consumer action on the payment collection request upon acceptance of the item by the consumer. The method includes rendering an authorization interface displaying the item-related information within a digital wallet of the consumer. The method further includes receiving a consumer authorization through the authorization interface for the item-related information. The method includes making the digital payment for the item via the digital wallet into a financial account of the merchant, in response to receiving the consumer authorization.

### CROSS REFERENCE TO RELATED APPLICATIONS

This application claims priority to Singapore Application Serial No. 10201706267U, filed Aug. 1, 2017, which is incorporated herein by reference in its entirety

### DESCRIPTION

### Technical Field

The present invention relates to digital payments, and in particular, to method, system, and device for processing digital payments via digital wallet upon delivery of item.

### Background

With the increased availability of smart devices and high speed internet, there has been an exponential growth in the number of consumers utilizing e-commerce platforms to purchase goods and services online. There are various payment modes that a consumer may opt for in order to purchase goods and services from an e-commerce merchant. The consumer may prepay the transaction amount online while placing the order, such that, a digital payment is made by the consumer, via, one or more of a credit card, debit card, a digital wallet, or a bank account. Alternatively, the consumer may choose the ‘cash on delivery’ payment mode while placing the order. In this case, the consumer completes the transaction only after receiving the goods or services by paying in cash upon delivery.

Though the ‘cash on delivery’ payment mode is the preferred choice of most e-commerce customers (70% according to some estimates) in developing countries, this payment mode causes multiple problems for the e-commerce merchants and the consumers. Some of these problems include, cash handling cost, cash and order reconciliation hassles, delay in receipt of cash, losses incurred in cash management, and exact cash requirements from the consumers.

There is therefore a need for a method and system that retains the benefits of the ‘cash on delivery’ payment mode, while eliminating the above discussed problems.

### SUMMARY

In one embodiment, a method of receiving a digital payment from a consumer upon delivery of an item is disclosed. The method includes generating a payment collection request that embeds item-related information. The item-related information includes at least details of a merchant selling the item, order details for the item, or a payment amount for the item. The method further includes sharing the payment collection request with the consumer, wherein activating the payment collection request upon acceptance of the item by the consumer renders an authorization interface displaying the item-related information within a digital wallet on a computing device of the consumer. The method includes receiving the digital payment for the item via the digital wallet into a financial account of the merchant, in response to the authorization of the payment collection request by the consumer through the authorization interface.

In another embodiment, a method of making a digital payment by a consumer upon delivery of an item is disclosed. The method includes receiving a payment collection request by the consumer. The payment collection request embeds item-related information that includes at least details of a merchant selling the item, order details for the item, or a payment amount for the item. The method further includes detecting, by a computing device associated with the consumer, a consumer action on the payment collection request upon acceptance of the item by the consumer. The method includes rendering, on the computing device, an authorization interface within a digital wallet of the consumer, wherein the authorization interface displays the item-related information retrieved from the payment collection request. The method further includes receiving, by the computing device, a consumer authorization through the authorization interface for the item-related information. The method includes making the digital payment for the item via the digital wallet into a financial account of the merchant, in response to receiving the consumer authorization through the authorization interface.

In yet another embodiment, a digital wallet server to facilitate a digital payment by a consumer upon delivery of an item is disclosed. The digital wallet server includes a processor; and a memory communicatively coupled to the processor, wherein the memory stores processor instructions, which, on execution, causes the processor to receive a consumer action on a payment collection request upon acceptance of the item by the consumer to activate the payment collection request. The payment collection request embeds item-related information comprising at least details of a merchant selling the item, order details for the item, or a payment amount for the item. The processor instructions further cause the processor to render an authorization interface within a digital wallet on a computing device of the consumer, wherein the authorization interface displays the item-related information retrieved from the payment collection request. The processor instructions cause the processor to receive a consumer authorization for the item-related information through the authorization interface. The processor instructions further cause the processor to make the digital payment for the item via a digital wallet account associated with the digital wallet into a financial account of the merchant, in response to receiving the consumer authorization through the authorization interface.

In one embodiment, a system to facilitate receipt of a digital payment made by a consumer upon delivery of an item is disclosed. The system includes a processor; and a memory communicatively coupled to the processor, wherein the memory stores processor instructions, which, on execution, causes the processor to generate a payment collection request that embeds item-related information comprising at least details of a merchant selling the item, order details for the item, or a payment amount for the item. The processor instructions further cause the processor to share the payment collection request with the consumer, wherein activating the payment collection request upon acceptance of the item by the consumer renders an authorization interface displaying the item-related information within a digital wallet on a computing device of the consumer. The processor instructions cause the processor to receive the digital payment for the item via the digital wallet into a financial account of the merchant, in response to the authorization of the payment collection request by the consumer from within the digital wallet.

In another embodiment, a non-transitory computer-readable storage medium having stored thereon, a set of computer-executable instructions is disclosed. The set of computer-executable instructions cause a computing device comprising one or more processors to perform steps including receiving a payment collection request by the consumer, wherein the payment collection request embeds item-related information comprising at least details of a merchant selling the item, order details for the item, or a payment amount for the item. The steps further include detecting a consumer action on the payment collection request upon acceptance of the item by the consumer. The steps include rendering an authorization interface within a digital wallet of the consumer, wherein the authorization interface displays the item-related information retrieved from the payment collection request. The steps further include receiving a consumer authorization through the authorization interface for the item-related information. The steps include making the digital payment for the item via the digital wallet into a financial account of the merchant, in response to receiving the consumer authorization through the authorization interface.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an environment for processing digital payments between a consumer and a merchant, in which various embodiment may be employed.

FIG. 2 illustrates a functional block diagram of the system for processing digital payments between a consumer and a merchant via a digital wallet upon delivery of an item to the consumer, in accordance with an embodiment.

FIG. 3 illustrates a flow chart of a method for making a digital payment by a consumer upon delivery of an item, in accordance with an embodiment.

FIG. 4 illustrates a flow chart of a method for receiving a digital payment by a merchant from a consumer upon delivery of an item to the consumer, in accordance with an embodiment.

FIG. 5 illustrates a flow chart of a method for receiving a digital payment by a merchant from a consumer upon delivery of an item to the consumer, in accordance with another embodiment.

FIG. 6 illustrates an information flow between a consumer, a merchant, and a delivery agent for processing a digital payment via a digital wallet, when the merchant shares a payment link with the consumer, in accordance with an exemplary embodiment.

FIG. 7 illustrates an information flow between a consumer, a merchant, and a delivery agent for processing a digital payment via a digital wallet, when the merchant shares an optical code with the consumer, in accordance with an exemplary embodiment.

FIG. 8 illustrates a payment flow between various entities to transfer a digital payment from a consumer to a merchant, in accordance with an exemplary embodiment.

FIG. 9 illustrates a payment flow between various entities to fund a digital wallet of a consumer, in accordance with an exemplary embodiment.

FIG. 10 illustrates a transaction flow between various entities involved in processing of a digital payment via a digital wallet between a consumer and a merchant 104 upon delivery of an item to the consumer, in accordance with an exemplary embodiment.

FIG. 11 illustrates a block diagram of an exemplary computer system for implementing various embodiments.

### DETAILED DESCRIPTION OF THE DRAWINGS

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

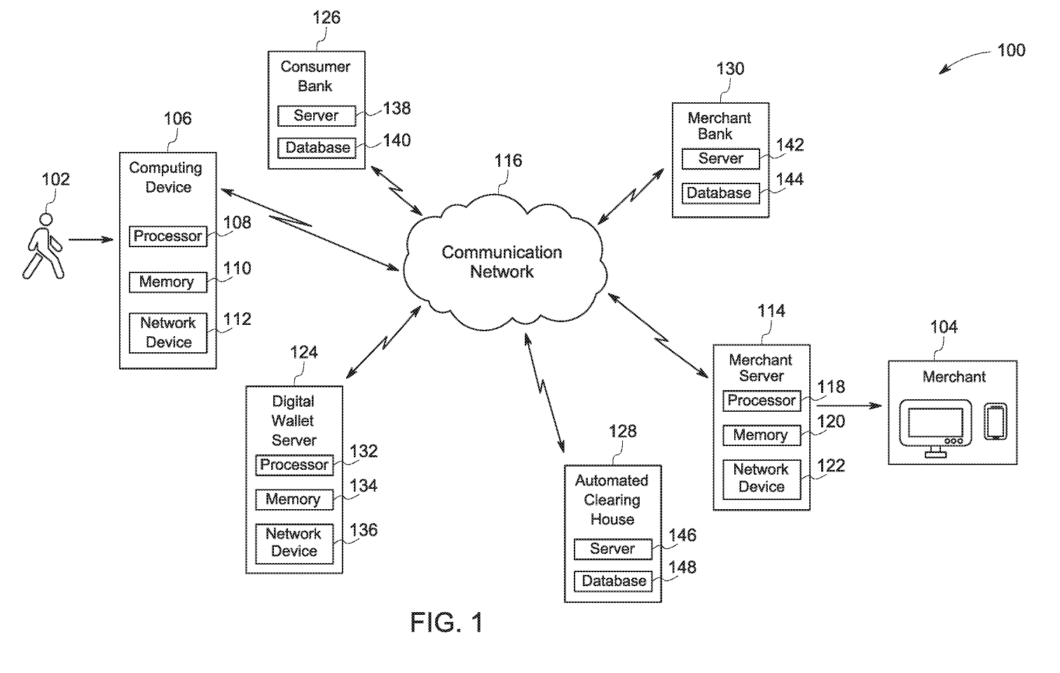

Additional illustrative embodiments are listed below. In one embodiment, an environment 100 for processing digital payments between a consumer 102 and a merchant 104 is illustrated in FIG. 1, in which various embodiments may be employed. The consumer 102 interacts with a computing device 106 to place an order for one or more items with the merchant 104. Examples of the computing device 106, may include but are not limited to a desktop, a laptop, a smart phone, a tablet, a cell phone, or a phablet. The item, for example, may include any goods or services provided by the merchant 104. The merchant 104 may be an e-commerce merchant (for example, Amazon®, Flipkart®, Snapdeal®, Lazada®, Zalora®, Redmart®, or ebay®), a food delivery service provider (for example, Swiggy®, Foodpanda®, Caviar®, or Munchery®), or any brick and mortar merchant. By way of an example, the consumer 102, through the computing device 106, may access a website or a mobile application of the merchant 104 to place an order for one or more items. By way of another example, the consumer 102 may place an order for one or more items by directly calling a contact number of the merchant 104 or by way of an in-person interaction with an executive or an agent of the merchant 104.

The computing device 106 may include a processor 108 for processing data and instructions received from the consumer 102 and other entities within the environment 100. Additionally, processor 108 coordinates with various other components (some of which may not be shown in FIG. 1) within the computing device 106. The computing device 106 may further include a memory 110 that stores data and instructions for processing by the processor 108. The computing device 106 also includes a network device 112 (for example, a transceiver or a network interface) that enables the communication device 106 to communicate with a merchant server 114 over a communication network 116, in order to place an order for one or more items with the merchant 104. Examples of the communication network 116 may include, but are not limited to cellular network via cell tower, broadband network such as the Internet, wireless network via access point.

In order to process the order placed by the consumer 102 via the computing device 106, the merchant server 114 also includes a processor 118, a memory 120, and a network device 122. Technical functionalities performed by each of the processor 118, the memory 120, and the network device 122 are respectively similar to that of the processor 108, the memory 110, and the network device 112.

The consumer 102 may make the payment for the one or more items by way of cash, when the one or more items are delivered or by way of digital payments at the time of placing the order. Digital payments may be made by the consumer 102 through the computing device 106 by using one or more of credit cards, debit cards, online transfer from bank accounts, or a digital wallet installed on the computing device 106. Thus, the computing device 106 may also be termed as a transaction device that enables the consumer 102 to make digital payments.

While digital payments are initiated at the computing device 106, they are processed and finally transferred to the merchant 104, over the communication network 116, through one or more of a digital wallet server 124 (associated with the digital wallet installed on the computing device 106), a consumer bank 126, an Automated Clearing House (ACH) 128 (for example, Mastercard®), and a merchant bank 130. In other words, one or more of the computing device 106, the consumer bank 126, the ACH 128, the merchant bank 130, and the merchant server 114 communicate with each other over the communication network 116.

The digital wallet server 124 further includes a processor 132, a memory 134, and a network device 136, which respectively have similar technical functionalities as the processor 118, the memory 120, and the network device 122 in the merchant server 114. It will be apparent to a person skilled in the art that though the digital wallet server 124 has been depicted as a separate entity, it may reside within any one of the consumer bank 126, the ACH 128 (for example, Mastercard®), and the merchant bank 130.

The consumer bank 126 may have issued a credit card, a debit card, a bank account, or a digital wallet account used by the consumer 102 to initiate the digital payment. In an embodiment, the consumer bank 126 may be replaced by a bank (different than the consumer bank 126) that processes the digital payment initiated by the consumer 102 before routing it to the consumer bank 126 via the ACH 128. The ACH 128 additionally enables communication between the consumer bank 126, the digital wallet server 124, and the merchant bank 130. The merchant bank 130 is a bank that issued a merchant bank account, which will finally receive the digital payment initiated by the consumer 102 at the computing device 106.

The consumer bank 126 includes a server 138 and a database 140, the merchant bank 130 includes a server 142 and a database 144, and the ACH 128 includes a server 146 and a database 148. The database 140 and 144 may include data related to bank users and their associated bank accounts, credit cards, debit cards and/or digital wallets. Similarly, the database 148 may include data related to associated banks and users to whom credit cards, debit cards, or digital wallets associated with the ACH 128 have been issued.

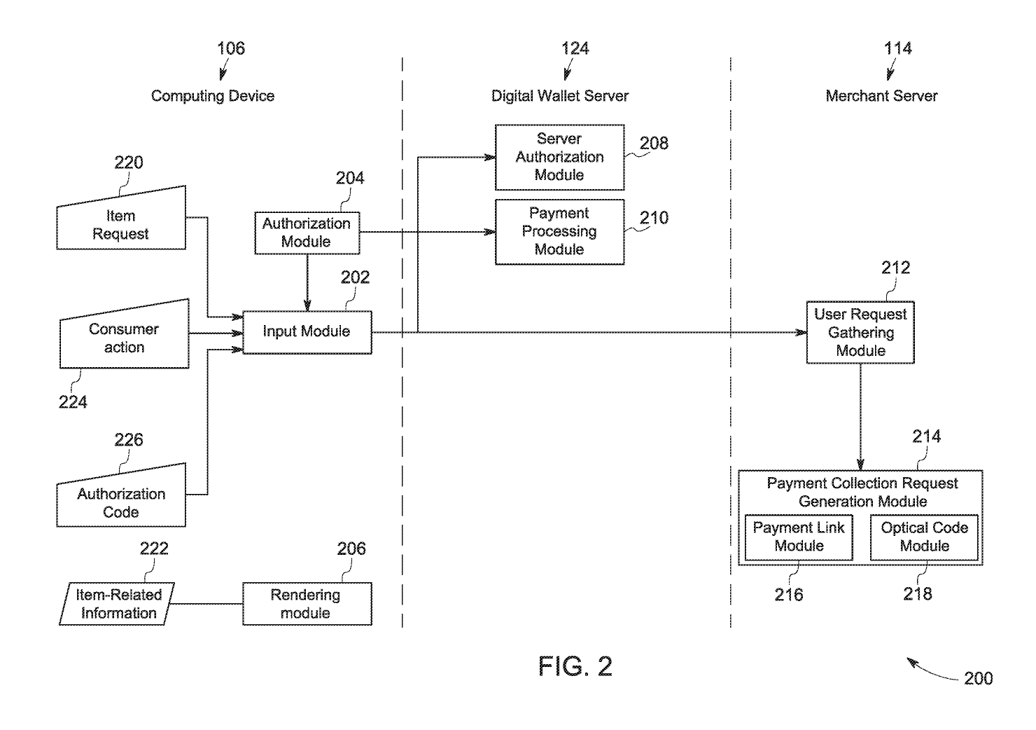

Referring now to FIG. 2, a functional block diagram of a system 200 for processing a digital payment between the consumer 102 and the merchant 104 via a digital wallet upon delivery of an item to the consumer 102 is illustrated, in accordance with an embodiment. To facilitate processing of the digital payment, the system 200 includes various modules that are distributed across the computing device 106, the digital wallet server 124, and the merchant server 114. These modules include an input module 202, an authorization module 204, and a rendering module 206 as part of the computing device 106; a server authorization module 208 and a payment processing module 210 as part of the digital wallet server 124; and a user request gathering module 212 and a payment collection request generation module 214, which further includes a payment link module 216 and an optical code module 218, as part of the merchant server 114. It will apparent to a person skilled in the art that location of modules within one of the computing device 106, the digital wallet server 124, and the merchant server 114 is merely for illustrative purpose and location of these modules is not limited to the depiction in FIG. 2.

In order to purchase an item, the consumer 102 may place an order for the item with the merchant 104 through the computing device 106. The order may also be placed by directly calling the merchant 104, through an Interactive Voice Response (IVR) menu, or by meeting the merchant 104 in person. The consumer 102, while placing the order, may be provided with an option to choose a payment mode for delivery of the item. In addition to the existing payment modes (i.e., prior digital payment or cash on delivery), the consumer 102 may also be provided with an option to select ‘payment on delivery’ as one of the payment modes. The ‘payment on delivery’ mode enables the consumer 102 to make a digital payment using a digital wallet installed on the computing device 106 upon delivery of the item. The option to select the ‘payment on delivery’ mode may be provided through a GUI of a merchant website or a mobile application owned by the merchant 104 or as part of the IVR menu. In an in-person or telephonic interaction, the consumer 102 and the merchant 104 may verbally agree to settle the payment for the item through the ‘payment on delivery’ mode.

When the consumer 102 places the order through the computing device 106, the input module 202 may receive an item request 220 provided by the consumer 102 through one or more of a keypad/keyboard, a touch screen, or a mic (when voice recognition is enabled) in the computing device 106. The item request 220, for example, may be for an item available on an ecommerce portal of the merchant 104 and may include details related to the item. Additionally, the item request 220 may include the payment mode selected by the consumer 102, while placing the order.

The input module 202 then provides the item request 220 to the user request gathering module 212. If the item request 220 includes ‘payment on delivery’ as the payment mode, the user request gathering module 212 instructs the payment collection request generation module 214 to generate a ‘payment collection request’ in which an item-related information 222 is embedded. The item-related information 222 includes one or more of: details of the merchant 104 selling the item, order details for the item, or a payment amount for the item. By way of an example, the item request 220 is placed with Amazon® for a smart phone of a particular brand. In this case, the item-related information 222 may include name of the merchant 104 (i.e., Amazon®), name of the brand, model number of the smart phone and its price.

The ‘payment collection request’ may either be generated as a payment link by the payment link module 216 or as an optical code by the optical code module 218. Example of the optical code may include, but are not limited to a Quick Response (QR) code, a bar code, a predefined image, a High Capacity Color Barcode (HCCB), a shot code, or a data matrix code. The mode of generating the ‘payment collection request’ may be based on a preregistered choice of the consumer 102 and/or the technical configuration of the computing device 106. By way of an example, if the computing device 106 does not have an inbuilt camera, then the ‘payment collection request’ may be generated as a payment link.

After generating the ‘payment collection request,’ the payment collection request generation module 214 shares the ‘payment collection request’ with the consumer 102. When the item is delivered to the consumer 102 by a delivery agent, the consumer 102 provides a consumer action 224 on the ‘payment collection request.’ The consumer action 224 is received by the input module 202, which then shares information regarding the consumer action 224 with the rendering module 206.

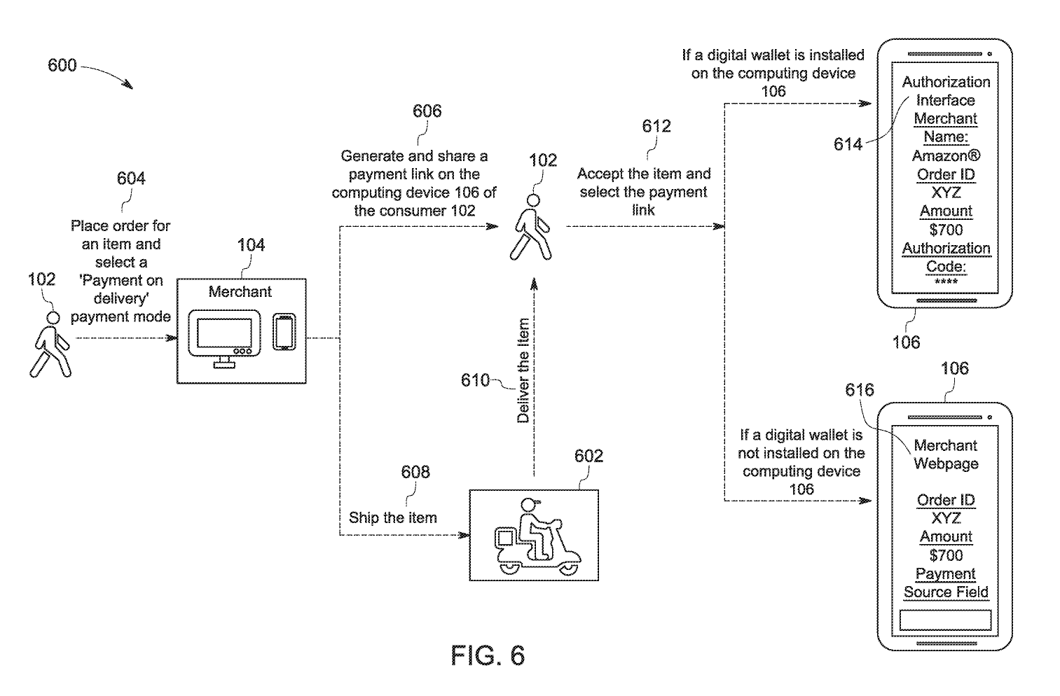

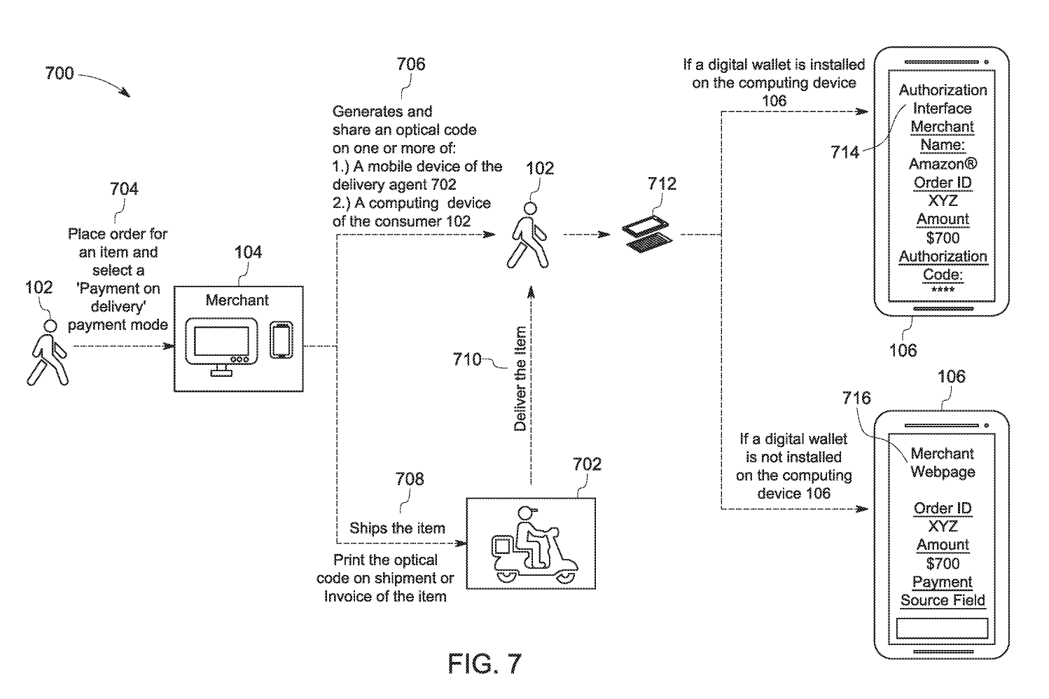

When the ‘payment collection request’ is a payment link, a notification that includes the payment link is shared on the computing device 106. In this case, the consumer action 224 may be selection of the payment link through a touch screen, joystick, or a mouse. In response to the selection, the rendering module 206 opens the digital wallet on the computing device 106 and displays the item-related information 222 in an authorization interface of the digital wallet. This is further explained in detail in conjunction with FIG. 6. However, when the ‘payment collection request’ is an optical code, it may be shared on one or more of a mobile device of a delivery agent, the computing device 106, a computing device of the consumer 102 that is registered with the merchant 104, or as a printout on a shipment package or invoice for the item. In this case, the consumer action 224 may be scanning the optical code from within the digital wallet. In response to the scanning, the rendering module 206 displays the item-related information 222 in the authorization interface of the digital wallet. This is further explained in detail in conjunction with FIG. 7.

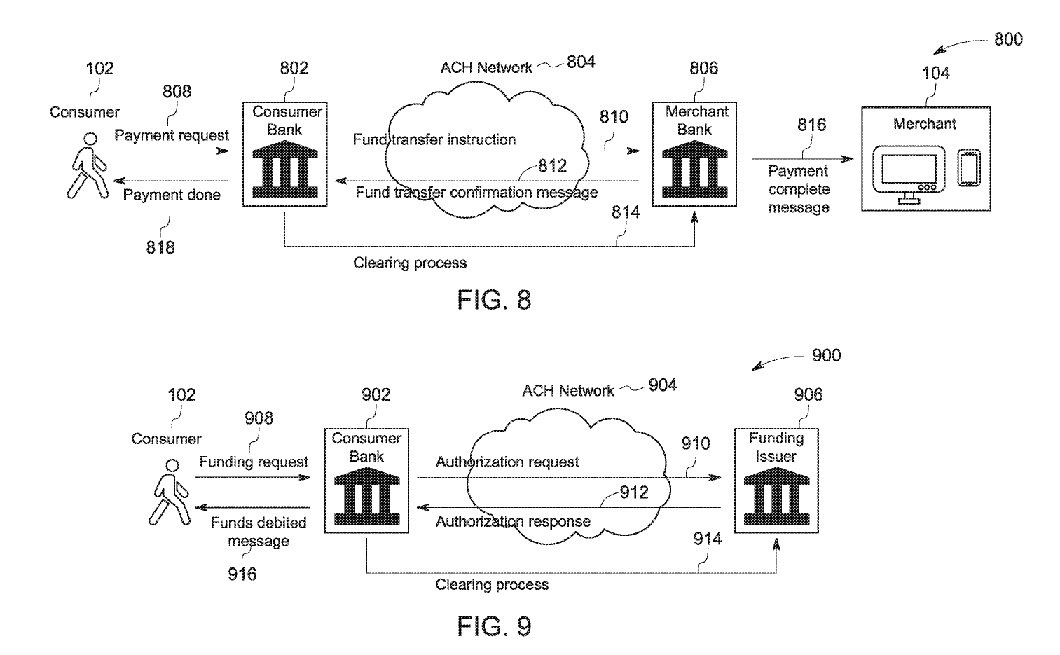

Once the item-related information 222 is displayed on a display screen of the computing device 106, the consumer 102 may review the item-related information 222 and may subsequently provide an authorization code 226 on the authorization interface. The authorization code 226 may be a numeric password, an alphanumeric password, a gesture, a touch screen pattern, or a voice command. The authorization code 226 is received by the input module 202 and shared with the authorization module 204, which verifies whether the authorization code 226 provided by the consumer 102 is correct or not. If the authorization code 226 is correct, the authorization module 204 instructs the payment processing module 210 to transfer the digital payment for the item to a financial account of the merchant 104. In an embodiment, instead of the authorization module 204, verification of the authorization code 226 may be performed by the server authorization module 208 in the digital wallet server 124. Thus, in this case, if the authorization code 226 is correct, the server authorization module 208 instructs the payment processing module 210 to transfer the digital payment. The process of transferring the digital payments from the digital wallet to the financial account of the merchant 104 is explained in detail in conjunction with FIGS. 8, 9, and 10.

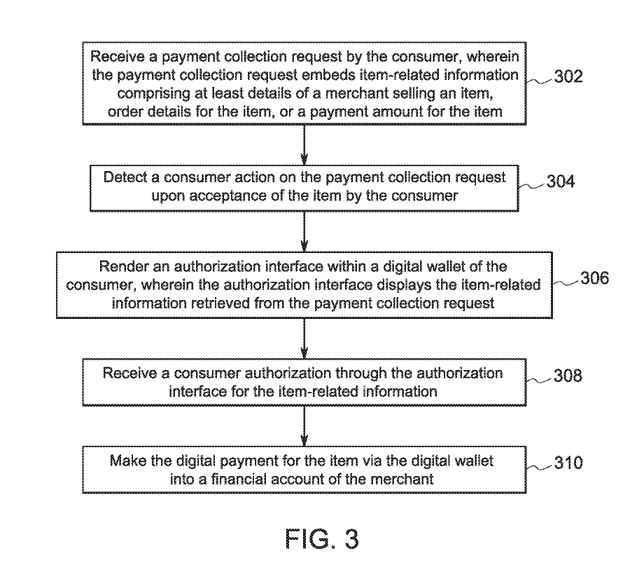

Referring now to FIG. 3, a flow chart of a method for making a digital payment by the consumer 102 upon delivery of an item is illustrated, in accordance with an embodiment. After the consumer 102 has placed an order for the item with the merchant 104, at step 302, a payment collection request is received at the computing device 106 by the consumer 102. In an embodiment, the payment collection request may be received at two or more computing devices associated with the consumer 102 and registered with the merchant 104. By way of an example, when the consumer 102 has registered two smart phones with the merchant 104 and has opted to receive the payment collection request at both the smart phones, the payment collection request may be sent to both the smart phones at the same time. The payment collection request embeds item-related information that includes, but is not limited to details of the merchant 104 (the selling merchant), order details for the item, or a payment amount for the item.

The payment collection request may either be generated as a payment link or as an optical code. Examples of the optical code may include, but are not limited to a QR code, a bar code, a predefined image, a HCCB, a shot code, or a data matrix code. In an embodiment, the mode of generating the payment collection request may be based on a preregistered requirement of the consumer 102 and/or based on the technical configuration of one or more computing devices associated with the consumer 102. The details regarding technical configuration of the one or more computing devices may be extracted by the merchant server 114 at the time of registration of the consumer 102. Alternatively, these details may be sent within the item request 220 to the merchant server 114. By way of an example, when the consumer 102 has opted to receive the payment collection request on two mobile devices, one of which does not have an inbuilt camera, the payment collection request may be shared as a payment link on the mobile device that does not have an inbuilt camera and as an optical code, to be used by the mobile device that has an inbuilt camera to scan the optical code.

When the payment collection request is generated as a payment link, a notification message that includes the payment link is shared with the computing device 106. The notification message may either be shared as a Short Messaging Service (SMS) or as a notification from the digital wallet installed on the computing device 106. Alternatively, when the payment collection request is generated as an optical code, the optical code may be received on a mobile device of a delivery agent and be later displayed to the consumer 102 at time of delivery of the item, the computing device 106 or a mobile device of the consumer 102, which is registered with the merchant 104, or as a printout on a shipment package or invoice for the item.

Upon acceptance of the item by the consumer 102 from the delivery agent, a consumer action on the payment collection request may be detected by the computing device 106, at step 304. Alternatively, or additionally, the consumer action may be detected by the digital wallet server 124. When the payment collection request is shared as a payment link in a notification message (an SMS), the consumer action includes opening the notification message and selecting the payment link. Similarly, when the notification message is received as a notification from the digital wallet installed on the computing device 106, the consumer action includes opening the notification. This is further explained in detail in conjunction with FIG. 6. However, when the payment collection request is shared as an optical code, the consumer action includes scanning the optical code from within the digital wallet using an inbuilt camera of the computing device 106. This is further explained in detail in conjunction with FIG. 7.

In response to the consumer action, an authorization interface within the digital wallet of the consumer 102 is rendered on the computing device 106, at step 306. The authorization interface displays the item-related information that was embedded in the payment collection request. In other words, the authorization interface upon being rendered is pre-populated with details included in the item-related information. In an embodiment, when the consumer action is selection or activation of a payment link, the consumer 102 is redirected to the authorization interface within the digital wallet in response to the selection. This is further explained in detail in conjunction with FIG. 6. In another embodiment, when the consumer action is scanning an optical code from within the digital wallet, the authorization interface is displayed within the digital wallet in response to scanning the optical code. This is further explained in detail in conjunction with FIG. 7.

After the consumer 102 has accepted the item and has reviewed the details of the item-related information displayed in the authorization interface, at step 308, a consumer authorization for the item-related information is received from the consumer 102, through the authorization interface, by the computing device 106. In an embodiment, the consumer authorization may be received by the digital wallet server 124. The consumer authorization may be provided by way of an authorization code received via the authorization interface. The authorization interface may have a field that receives the authorization code. Alternatively, an authorization button may be provided in the authorization interface along with the displayed item-related information, and activation of the authorization button by the consumer 102 may prompt the consumer 102 to provide the authorization code. The authorization code, for example, may be a numeric password, an alphanumeric password, a gesture, a touch screen pattern, or a voice command.

In response to receiving the consumer authorization, the digital payment for the item is made via the digital wallet into a financial account of the merchant 104, at step 310. The digital payment initiated from the digital wallet is routed from a consumer bank entity (for example, the consumer bank 126) associated with the digital wallet to an ACH entity (for example, the ACH 128) to a merchant bank entity (for example, the merchant bank 130) that issued the financial account associated with the merchant 104. The financial account of the merchant 104 may be one of a bank account, a digital wallet account, a payment card account, or an account with a payment bank. The processing of digital payment is further explained in detail in conjunction with FIGS. 8, 9, and 10.

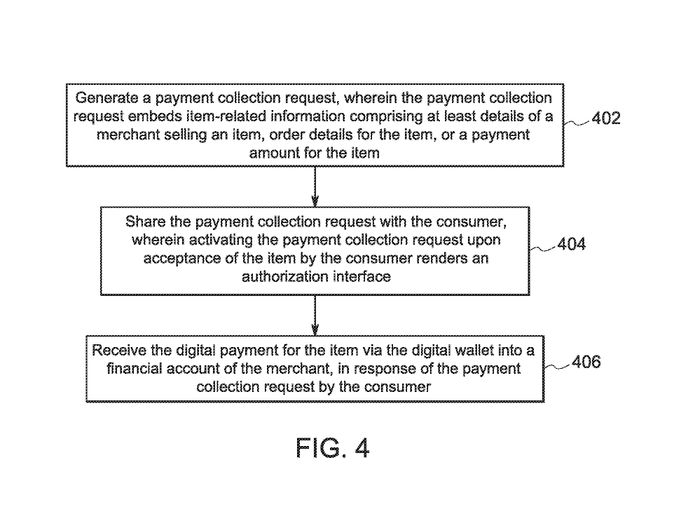

Referring now to FIG. 4, a flow chart of a method for receiving a digital payment by the merchant 104 from the consumer 102 upon delivery of an item to the consumer 102 is illustrated, in accordance with an embodiment. After the consumer 102 has placed an order for the item, an item request is received from the consumer 102 at the merchant server 114. The merchant server 114 may read the item request to determine whether the consumer 102 had selected the ‘payment on delivery’ mode or not. If the ‘payment on delivery’ mode was selected by the consumer 102, a payment collection request that embeds item-related information is generated at step 402. The payment collection request may either be generated as a payment link or an optical code. The merchant server 114 may decide the mode of generating the payment collection request based on technical configuration of computing devices of the consumer 102 registered with the merchant 104. This has already been explained in detail in conjunction with FIG. 2 and FIG. 3.

At step 404, the payment collection request is shared with the consumer 102. The mode of sharing the payment collection request has already been explained in detail in conjunction with FIG. 2 and FIG. 3. When the consumer 102 activates the payment collection request upon acceptance of the item, an authorization interface displaying the item-related information within a digital wallet is rendered on the computing device 106. After reviewing the item-related information, the consumer 102 may authorize the item-related information through the authorization interface. This has already been explained in detail in conjunction with FIG. 2 and FIG. 3. In response to the authorization of the payment collection request, the digital payment for the item is received into a financial account of the merchant 104 (the selling merchant) via the digital wallet at step 406. The processing of digital payment is further explained in detail in conjunction with FIGS. 8, 9, and 10.

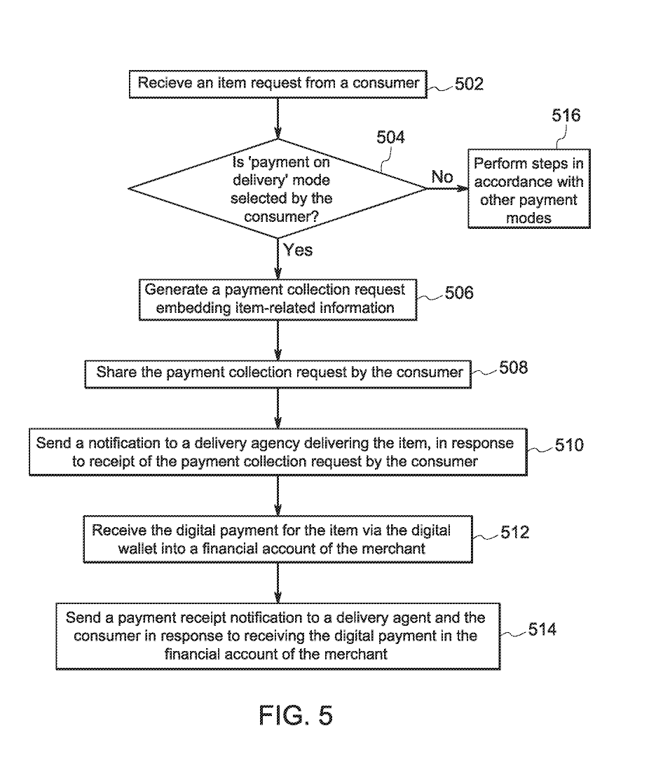

Referring now to FIG. 5, a flow chart of a method for receiving a digital payment by the merchant 104 from the consumer 102 upon delivery of an item to the consumer 102 is illustrated, in accordance with another embodiment. At step 502, an item request is received at the merchant server 114. At step 504, a check is performed to determine whether the consumer 102 had opted for the ‘payment on delivery’ mode. If the consumer 102 had opted for the ‘payment on delivery’ mode, a payment collection request that embeds item-related information is generated at step 506. At step 508, the payment collection request is shared with the consumer 102. This has already been explained in detail in conjunction with FIG. 4.

Thereafter, at step 510, a notification is sent to a delivery agency that would deliver the item to the consumer 102. The notification may include information that the payment collection request has been shared with the consumer 102 and the mode of sharing the payment collection request (i.e., as a payment link or an optical code). This information may enable the delivery agency to accordingly select a mobile device to be assigned to a delivery agent. By way of an example, if the payment collection request is to be shared as an optical code with the consumer 102, a delivery agent may be given a mobile device that is capable of displaying optical codes, which would subsequently be scanned by the consumer 102.

Upon authorization of the item-related information by the consumer 102, the digital payment for the item is received into a financial account of the merchant 104 via the digital wallet of the consumer 102, at step 512. In response to this, a payment receipt notification is sent to the delivery agent and to the consumer 102, at step 514. This enables the delivery agent to know that the digital payment has been received by the merchant 104 and he/she can leave the premises of the consumer 102. Referring back to step 504, if the ‘payment on delivery’ mode is not selected by the consumer 102, the control proceeds to step 516, where steps in accordance with other payment modes are performed. Other payment modes may include cash on delivery or prepaid payments (i.e., through credit cards, debit cards, digital wallets, or net banking). As these steps are not within the scope of the invention, they are not discussed here.

Referring now to FIG. 6, an information flow 600 between the consumer 102, the merchant 104, and a delivery agent 602 for processing a digital payment via a digital wallet, when the merchant 104 shares a payment link with the consumer 102, is illustrated, in accordance with an exemplary embodiment. The consumer 102, at step 604 places an order for an item with the merchant 104 and selects ‘payment on delivery’ as the payment mode while placing the order. The merchant server 114 of the merchant 104, at step 606, generates and shares a payment link on the computing device 106 of the consumer 102. The payment link may either be shared within an SMS or as a notification from the digital wallet installed on the computing device 106. The payment link is embedded with item-related information, which has been explained in detail in conjunction with FIG. 2 and FIG. 3.

Thereafter, the merchant 104, at step 608, ships the item through the delivery agent 602. The delivery agent 602, at step 610, delivers the item to the consumer 102. The consumer 102 accepts the item and selects the payment link, at step 612. In response to selection of the payment link, if the digital wallet is installed on the computing device 106, an authorization interface 614 is rendered within the digital wallet on the computing device 106. The authorization interface 614 includes name of the merchant (i.e., Amazon®), order ID, the payment amount for the item, and a field to enter the authorization code. Once the consumer 102 provides the authorization code, the digital payment is transferred from the digital wallet to a financial account of the merchant 104.

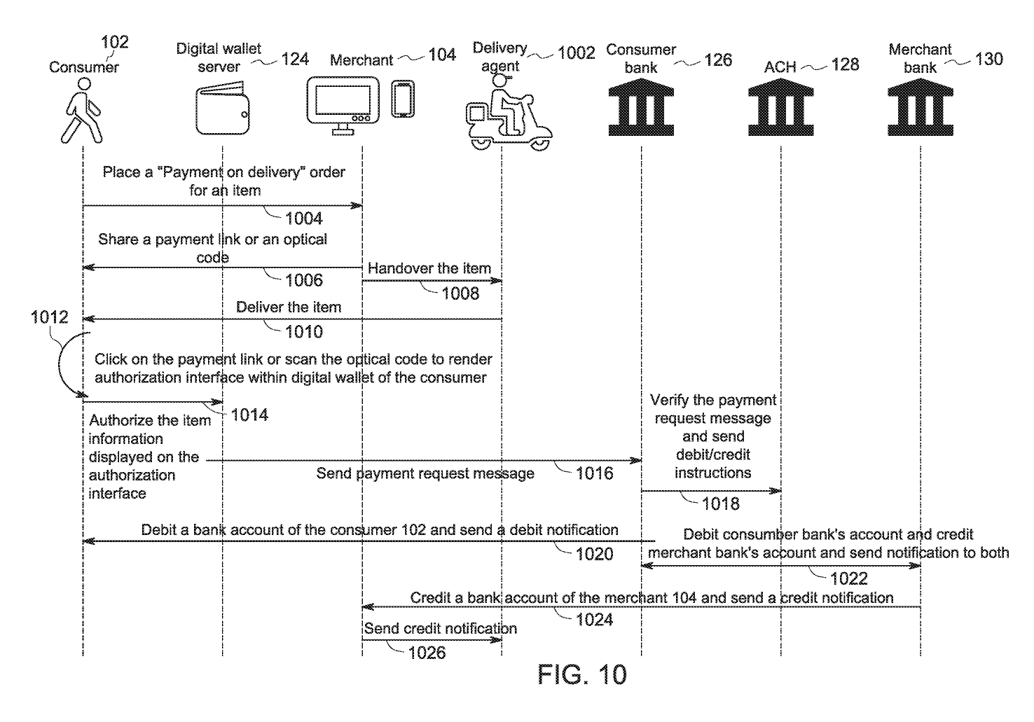

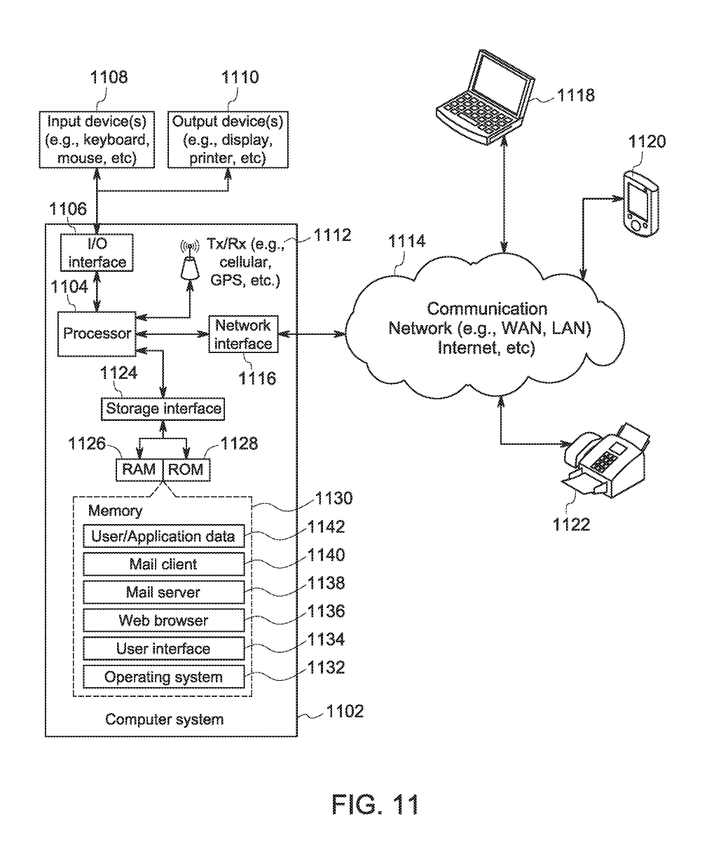

However, if the digital wallet is not installed on the computing device 106, a merchant webpage 616 opens on a web browser application in the computing device 106, in response to selection of the payment link. The consumer 102 may then provide details of the source of payment (for example, credit/debit card, bank account, or digital wallet) on a payment source field within the merchant webpage 616. The digital payment is then deducted from the source of payment and transferred to the financial account of the merchant 104. The transfer of digital payment from the consumer 102 to the merchant 104 is explained in detail in conjunction with FIG. 8 and FIG. 10.

Referring now to FIG. 7, an information flow 700 between the consumer 102, the merchant 104, and a delivery agent 702 for processing a digital payment via a digital wallet, when the merchant 104 shares an optical code with the consumer 102, is illustrated, in accordance with an exemplary embodiment. The consumer 102, at step 704 places an order for an item with the merchant 104 and selects ‘payment on delivery’ as the payment mode while placing the order. The merchant server 114 of the merchant 104, at step 706, generates an optical code. Additionally, the merchant server 114, at step 706, shares the optical code on one or more of a mobile device of the delivery agent 702 or a computing device (for example, the computing device 106) of the consumer 102. The optical code is embedded with item-related information, which has been explained in detail in conjunction with FIG. 2 and FIG. 3.

Thereafter, the merchant 104, at step 708, ships the item through the delivery agent 702. Additionally, at step 708, while shipping the item, the merchant 104 may print the optical code on the shipment or invoice of the item. The delivery agent 702, at step 710, delivers the item to the consumer 102. The consumer 102 accepts the item and scans the optical code, at step 712. The optical code may be displayed to the user on the mobile device of the delivery agent 702, on a computing device of the consumer 102 (other than the computing device 106), or on the shipment or invoice of the item. To scan the optical code, the consumer 102 scans the optical code through an inbuilt camera of the computing device 106.

In response to scanning of the optical code, if the digital wallet is installed on the computing device 106, an authorization interface 714 is rendered within the digital wallet on the computing device 106. The authorization interface 714 includes name of the merchant (i.e., Amazon®), order ID, the payment amount for the item, and a field to enter the authorization code. Once the consumer 102 provides the authorization code, the digital payment is transferred from the digital wallet to a financial account of the merchant 104.

However, if the digital wallet is not installed on the computing device 106, a merchant webpage 716 opens on a web browser application, in response to scanning the optical code. The consumer 102 may then provide details of the source of payment (for example, credit/debit card, bank account, or digital wallet) on a payment source field within the merchant webpage 716. The digital payment is then deducted from the source of payment and transferred to the financial account of the merchant 104. The transfer of digital payment from the consumer 102 to the merchant 104 is explained in detail in conjunction with FIG. 8 and FIG. 10.

Referring now to FIG. 8, a payment flow 800 between various entities to transfer a digital payment from the consumer 102 to the merchant 104 is illustrated, in accordance with an exemplary embodiment. The various entities involved in the payment flow 800 include a consumer bank 802 (analogous to the consumer bank 126), an ACH network 804 (analogous to the ACH 128), and a merchant bank 806 (analogous to the merchant bank 130). When the digital payment for a payment amount is initiated by the consumer 102 from a digital wallet installed on the computing device 106 (not shown in FIG. 8), a payment request 808 is sent from the computing device 106 to the consumer bank 802. The consumer bank 802 may be a bank (for example, the Standard Chartered® bank) that had provided the digital wallet to the consumer 102. In an embodiment, the digital wallet may have been provided by a non-banking financial entity (for example, Paytm®, PayPal®, Apple®, Mastercard®). In this case, the payment request 808 may be routed through a digital wallet server (not shown in FIG. 8) to the consumer bank 802.

In response to the payment request 808, the consumer bank 802 debits the payment amount from the digital wallet of the consumer 102 and sends a fund transfer instruction 810 through the ACH network 804 to the merchant bank 806. Based on the information in the fund transfer instruction 810, the ACH network 804 identifies the merchant bank 806, to which the fund transfer instruction 810 is to be routed. The merchant bank 806 is the bank where the merchant 104 has a bank account. On receipt of the fund transfer instruction 810, the merchant bank 806 credits the bank account of the merchant 104 with the payment amount for the item and sends a fund transfer confirmation message 812 to the consumer bank 802 through the ACH network 804. A clearing process 814 is subsequently performed between the consumer bank 802 and the merchant bank 806.

When the bank account of the merchant 104 is credited with the payment amount, the merchant bank 806 sends a payment complete message 816 to the merchant 104. Similarly, when the consumer bank 802 receives the fund transfer confirmation message 812, the consumer bank 802 sends a payment complete message 818 to the consumer 102, indicating that the bank account of the merchant 104 has been credited.

However, in some cases, the consumer 102 may not be able to initiate the digital payment because of insufficient funds in the digital wallet. In this case, a funding request may be initiated by the digital wallet from the computing device 106, in order to complete the digital payment. This is further explained in detail in conjunction with FIG. 9.

Referring now to FIG. 9, a payment flow 900 between various entities to fund a digital wallet of the consumer 102 is illustrated, in accordance with an exemplary embodiment. The various entities involved in the payment flow 900 include a consumer bank 902 (analogous to the consumer bank 126), an ACH network 904 (analogous to the ACH 128), and a fund issuer 906, which issues funds in order to add balance into the digital wallet installed on the computing device 106 (not shown in FIG. 8).

When the digital wallet has insufficient funds to initiate a digital payment for an item, a funding request 908 for a particular funding amount is initiated from the digital wallet. The consumer 102 may have used a credit card, a debit card, or a bank account provided by the funding issuer 906 as a funding source to initiate the funding request 908. After being initiated, the funding request 908 is sent from the computing device 106 to the consumer bank 902, which may be a bank (for example, the Standard Chartered® bank or the Bank Of America®) that had provided the digital wallet to the consumer 102. In an embodiment, the digital wallet may have been provided by a non-banking financial entity (for example, Paytm®, PayPal®, Apple®, or Mastercard®). In this case, the funding request 908 may be routed through a digital wallet server (not shown in FIG. 8) to the consumer bank 902.

In response to the funding request 908, the consumer bank 902 sends an authorization request 910 through the ACH network 904 to the funding issuer 906. Based on the information in the authorization request 910, the ACH network 904 identifies the funding issuer 906, to which the authorization request 910 is to be routed. By way of an example, the digital wallet may be provided by the Standard Chartered® bank and the consumer may want to add funds from a credit card issued by Bank Of America®. In this case, the Standard Chartered® bank is the consumer bank 902, while Bank Of America® is the funding issuer 906.

On receipt of the authorization request 910, the funding issuer 906 may verify credential provided by the consumer 102 and after verification may send an authorization response 912 to the consumer bank 902 through the ACH network 904. The authorization response 912 instructs the consumer bank 902 to credit the digital wallet of the consumer 102 with the funding amount. A clearing process 914 is subsequently performed between the consumer bank 902 and the funding issuer 906. When the digital wallet of the consumer is credited with the funding amount, the consumer bank 902 sends a funds debited message 916 to the consumer 102. Thereafter, the consumer 102 may initiate the digital payment for the item from the digital wallet.

Referring now to FIG. 10, a transaction flow 1000 between various entities involved in processing of a digital payment via a digital wallet between the consumer 102 and the merchant 104 upon delivery of an item to the consumer 102 is illustrated, in accordance with an exemplary embodiment. The various entities in the transaction flow 1000 include the consumer 102, the digital wallet server 124, the merchant 104, a delivery agent 1002, the consumer bank 126, the ACH 128, and the merchant bank 130.

At step 1004, the consumer 102 places a ‘payment on delivery’ order for the item with the merchant 104. In response, the merchant 104 shares a payment link or an optical code with the consumer 102 at step 1006. Each of the payment link or the optical code embed item-related information, which has already been explained in detail in conjunction with FIG. 2 and FIG. 3. At step 1008, the merchant 104 handovers the item to the delivery agent 1002 in order to ship it to the consumer 102. It will be apparent to a person skilled in the art that that the order of performing the steps 1006 and 1008 are interchangeable.

At step 1010, the delivery agent 1002 delivers the item to the consumer 102. At step 1012, the consumer 102 clicks on the payment link or scans the optical code to render an authorization interface within the digital wallet of the consumer 102. The authorization interface displays the item-related information for review by the consumer 102. Based on the review, at step 1014, the consumer 102 authorizes the item-related information displayed on the authorization interface from within the digital wallet. The authorization is received by the digital wallet sever 124, which sends a payment request message to the consumer bank 126 at step 1016. The consumer bank 126 may be a bank that provided the digital wallet or a bank with which the digital wallet provider has an account.

At step 1018, the consumer bank 126 verifies the payment request message and post verification sends debit/credit instructions to the ACH 128. Thereafter, at step 1020, the consumer bank 126 debits the bank account of the consumer 102 and sends debit notification to the consumer 102 via the digital wallet server 124. Based on the debit/credit instruction, the ACH 128, at step 1022, debits a payment amount for the item from an account of the consumer bank 126 and credits an account of the merchant bank 130 with the payment amount. The merchant bank 130, at step 1024, credits a bank account of the merchant 104 and sends a credit notification to the merchant 104. Upon receipt of the credit notification, at step 1026, the merchant 104 sends a credit notification to the delivery agent 1002, so that the delivery agent 1002 can leave premises of the consumer 102.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

The disclosed methods and systems may be implemented on a conventional or a general-purpose computer system, such as a personal computer (PC) or server computer. Referring now to FIG. 11, a block diagram of an exemplary computer system 1102 for implementing embodiments consistent with the present disclosure is illustrated. Variations of the computer system 1102 may be used for implementing system 200 for processing digital payments via digital wallets between the consumer 102 and the merchant 104, upon delivery of one or more items to the consumer. The computer system 1102 may include a central processing unit (“CPU” or “processor”) 1104. The processor 1104 may include at least one data processor for executing program components for executing user-generated or system-generated requests. A user may include a person, a person using a device such as such as those included in this disclosure, or such a device itself. The processor 1104 may include specialized processing units such as integrated system (bus) controllers, memory management control units, floating point units, graphics processing units, digital signal processing units, etc. The processor 1104 may include a microprocessor, such as AMD Athlon, Duron or Opteron, ARM's application, embedded or secure processors, IBM PowerPC, Intel's Core, Itanium, Xeon, Celeron or other line of processors, etc. The processor 1104 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

The processor 1104 may be disposed in communication with one or more input/output (I/O) devices via an I/O interface 1106. The I/O interface 1106 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 1106, the computer system 1102 may communicate with one or more I/O devices. For example, an input device 1108 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 1110 may be a printer, fax machine, video display (e.g., cathode ray tube (CRT), liquid crystal display (LCD), light-emitting diode (LED), plasma, or the like), audio speaker, etc. In some embodiments, a transceiver 1112 may be disposed in connection with the processor 1104. The transceiver 1112 may facilitate various types of wireless transmission or reception. For example, the transceiver 1112 may include an antenna operatively connected to a transceiver chip (e.g., Texas Instruments WiLink WL1283, Broadcom BCM4760IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 1104 may be disposed in communication with a communication network 1114 via a network interface 1116. The network interface 1116 may communicate with the communication network 1114. The network interface 1116 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 1114 may include, without limitation, a direct interconnection, local area network (LAN), wide area network (WAN), wireless network (e.g., using Wireless Application Protocol), the Internet, etc. Using the network interface 1116 and the communication network 1114, the computer system 1102 may communicate with devices 1118, 1120, and 1122. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 1102 may itself embody one or more of these devices.

In some embodiments, the processor 1104 may be disposed in communication with one or more memory devices (e.g., a RAM 1126, a ROM 1128, etc.) via a storage interface 1124. The storage interface 1124 may connect to a memory 1130 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory 1130 may store a collection of program or database components, including, without limitation, an operating system 1132, a user interface 1134, a web browser 1136, a mail server 1138, a mail client 1140, a user/application data 1142 (e.g., any data variables or data records discussed in this disclosure), etc. The operating system 1132 may facilitate resource management and operation of the computer system 1102. Examples of the operating system 1132 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. The user interface 1134 may facilitate display, execution, interaction, manipulation, or operation of program components through textual or graphical facilities. For example, user interfaces may provide computer interaction interface elements on a display system operatively connected to the computer system 1102, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 1102 may implement a web browser 1136 stored program component. The web browser 1136 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 1102 may implement the mail server 1138 stored program component. The mail server 1138 may be an Internet mail server such as Microsoft Exchange, or the like. The mail server 1138 may utilize facilities such as ASP, ActiveX, ANSI C++/C#, Microsoft .NET, CGI scripts, Java, JavaScript, PERL, PHP, Python, WebObjects, etc. The mail server 1138 may utilize communication protocols such as internet message access protocol (IMAP), messaging application programming interface (MAPI), Microsoft Exchange, post office protocol (POP), simple mail transfer protocol (SMTP), or the like. In some embodiments, the computer system 1102 may implement the mail client 1140 stored program component. The mail client 1140 may be a mail viewing application, such as Apple Mail, Microsoft Entourage, Microsoft Outlook, Mozilla Thunderbird, etc.

In some embodiments, the computer system 1102 may store the user/application data 1142, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

As will be appreciated by those skilled in the art, the techniques described in the various embodiments discussed above enable a merchant to provide a ‘payment on delivery’ payment mode to the consumer, such that, the consumer can seamlessly make a digital payment upon delivery of the item using his/her digital wallet. Thus, the consumer is able to avail the benefits of the ‘cash on delivery’ payment mode, without creating any overheads related to cash management for the merchant. As a result, the merchants (especially, e-commerce merchants), irrespective of completely adopting digital payment methods, are able to retain their ‘cash on delivery’ customers.

The specification has described method, system, and device for processing digital payments via digital wallet upon delivery of items. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method of receiving a digital payment from a consumer upon delivery of an item, the method comprising:
generating a payment collection request, wherein the payment collection request embeds item-related information comprising at least details of a merchant selling the item, order details for the item, or a payment amount for the item;
sharing the payment collection request with the consumer, wherein activating the payment collection request upon acceptance of the item by the consumer renders an authorization interface displaying the item-related information within a digital wallet on a computing device of the consumer; and
receiving the digital payment for the item via the digital wallet into a financial account of the merchant, in response to the authorization of the payment collection request by the consumer through the authorization interface.

2. The method of claim 1, further comprising sending a notification to a delivery agent delivering the item in response to receipt of the payment collection request by the consumer.

3. The method of claim 1, further comprising sending a payment receipt notification to a delivery agent and the consumer in response to receiving the digital payment in the financial account of the selling merchant.

4. The method of claim 1, wherein the payment collection request is a payment link within a notification message shared with the computing device.

5. The method of claim 4, wherein activation of the payment link within the notification message by the consumer redirects the consumer to the authorization interface displaying the item-related information.

6. The method of claim 1, wherein the payment collection request is an optical code comprising at least one of a Quick Response (QR) code, a bar code, a predefined image, a High Capacity Color Barcode (HCCB), a shot code, or a data matrix code.

7. The method of claim 6, wherein the optical code is shared on at least one of: a mobile device of a delivery agent, a mobile device of the consumer registered with the selling merchant, or as a printout on a shipment package or invoice for the item.

8. The method of claim 6, wherein the consumer activates the optical code by scanning the optical code using a camera within the computing device of the consumer, and wherein scanning the optical code renders the authorization interface within the digital wallet.

9. The method of claim 1, wherein the digital payment initiated from the digital wallet is routed from a consumer bank entity associated with the digital wallet to an automated clearing house entity to a merchant bank entity that issued the financial account associated with the merchant.

10. The method of claim 1, wherein the financial account of the merchant is one of a bank account, a digital wallet, a payment bank account, or a payment card account.

11. The method of claim 1, wherein the consumer authorizes the payment collection request by providing an authorization code via the authorization interface.

12. A digital wallet server to facilitate a digital payment by a consumer upon delivery of an item comprising:
a processor; and
a memory communicatively coupled to the processor, wherein the memory stores processor instructions, which, on execution, causes the processor to:
receive a consumer action on a payment collection request upon acceptance of the item by the consumer to activate the payment collection request, wherein the payment collection request embeds item-related information comprising at least details of a merchant selling the item, order details for the item, or a payment amount for the item;
render an authorization interface within a digital wallet on a computing device of the consumer, wherein the authorization interface displays the item-related information retrieved from the payment collection request;
receive a consumer authorization for the item-related information through the authorization interface; and
make the digital payment for the item via a digital wallet account associated with the digital wallet into a financial account of the merchant, in response to receiving the consumer authorization through the authorization interface.

13. The digital wallet server of claim 12, wherein the payment collection request is one of a payment link or an optical code.

14. The digital wallet server of claim 13, wherein the consumer action comprises selecting the payment link or scanning the optical code.

15. A system to facilitate receipt of a digital payment made by a consumer upon delivery of an item comprising:
a processor; and
a memory communicatively coupled to the processor, wherein the memory stores processor instructions, which, on execution, causes the processor to:
generate a payment collection request, wherein the payment collection request embeds item-related information comprising at least details of a merchant selling the item, order details for the item, or a payment amount for the item;
share the payment collection request with the consumer, wherein activating the payment collection request upon acceptance of the item by the consumer renders an authorization interface displaying the item-related information within a digital wallet on a computing device of the consumer; and
receive the digital payment for the item via the digital wallet into a financial account of the merchant, in response to the authorization of the payment collection request by the consumer from within the digital wallet.

16. The system of claim 15, wherein the processor instructions further cause the processor to send a notification to a delivery agent delivering the item in response to receipt of the payment collection request by the consumer.

17. The system of claim 15, wherein the processor instructions further cause the processor to send a payment receipt notification to a delivery agent and the consumer in response to receiving the digital payment in the financial account of the merchant.

18. The system of claim 15, wherein the processor receives an item request to purchase the item through an e-commerce portal of the merchant, and wherein the payment collection request is generated based on the item request.
